(19) United States
(12) Patent Application Publication
(10) Pub. No.: US 2006/0171144 A1
(43) Pub. Date: Aug. 3, 2006

(54) Stormer hi-tech super halogen spotlight

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/050,315

(22) Filed: Feb. 3, 2005

(51) Int. Cl. F21L 4/00

(52) U.S. Cl. 362/158

(57) ABSTRACT

The present invention relates to a stormer Hi-tech halogen spotlight, and more particularly relates to a halogen spotlight equipped with a circuit adopts direct current power supply, power generated by automobile and batteries along with an exhaust pipe at its end portion to release exceed air pressure within said halogen spotlight due to changes of weather and climate. It also has a handle bar; it also can stand for changes due to weather without affecting its performance Said halogen spotlight provides its users with lighting whether indoors or outdoors, in any condition and climate and very user friendly and especially useful for high-risk workers, such as navy, marine, land force, infantry, field army and air force, aerospace technicians, armed police, firefighters, riot police, special troops, public security station, disciplined force, emergency treatment, civil construction and vessels, and indispensable for amateurs of hiking, suburban expeditions, fishing and alpine skiing.

### BACKGROUND OF THE PRESENT INVENTION

The present invention relates to a halogen spotlight, and more particularly relates to a halogen spotlight equipped with a circuit adopts direct current power supply, power generated by automobile and batteries along with an exhaust pipe at its end portion to release exceed air pressure within said halogen spotlight due to changes of weather and climate.

1. Field of Invention

Majority of conventional halogen spotlight normally consist of a main body and a spotlight, however, they always have a flaw such as they can only employ a single source of power supply. When such single source of power supply went out, halogen spotlights are useless unless a replacement of power supply occurred. However, it is very inconvenient to replace lighting source when use halogen spotlight during life-saving actions and during any policing or military strikes.

Moreover, most conventional halogen spotlights cannot adopt changes due to weather and climates. Most of the times we find halogen spotlights are exploded due to exceed air pressure caused by weather and climates. It is very dangerous for users.

Also, most conventional halogen spotlights provide can only adopt one power source, normally power generated by batteries. It is very inconvenient for users when using such halogen spotlights in different occasions.

2. Description of Related Arts

### SUMMARY OF THE PRESENT INVENTION

A main object for the present invention is to provide a halogen spotlight having adoptability to more than one power supply source.

Another object for the present invention is to provide a halogen spotlight having adoptability to any changes of weather and climates therefore; it will not be exploded so easily.

Another object for the present invention is to provide a halogen spotlight having adoptability to allow regular batteries combined into a bigger power supply for extended usage.

Another object for the present invention is to provide a halogen spotlight having a supporting means and such supporting mean can provide an ability to rotate and/or to move any angles within 270 degree circular arc.

Accordingly, in order to accomplish the above objects, the present invention provides a halogen spotlight comprising:
a three-dimensional-type-cylinder structure body, within which there is an inner chamber, a spotlight unit chamber at one end serves as a lighting source, and
an electric circuit device to provide power supply and adoptability to rechargeable batteries, and
a detachable power box for batteries is placed at rear end portion of an electric circuit within the body providing the ability to combine batteries into a bigger power supply for extended usage, and
a plurality of supporting mean can provide an ability to rotate and/or to move any angles within 270° circular arc, and
an arrangement for an exhaust pipe, comprises:
an annular nut made of flexible material and seals up the exit of the exhaust pipe from the top, so that rain does not run through the exit of the exhaust pipe to enter the body, wherein, should the air pressure and temperature inside the body are higher than those outside the body, the air will discharge out of the body through the annular nut made of flexible materials at the exit of the exhaust pipe.

### BRIEF DESCRIPTION OF THE DRAWINGS

FIG. 1 is a side view of the present invention;

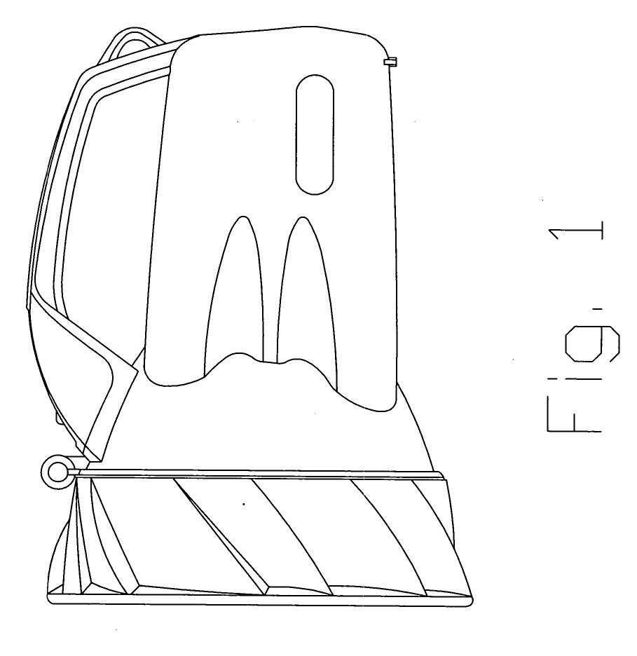

FIG. 2 is a sectional side showing chargeable battery therefore;

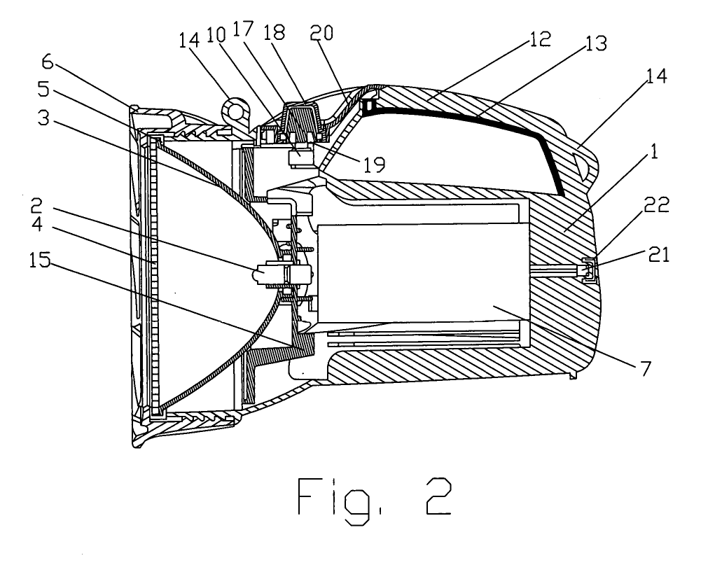

FIG. 3 is a sectional side view showing standard battery thereof,

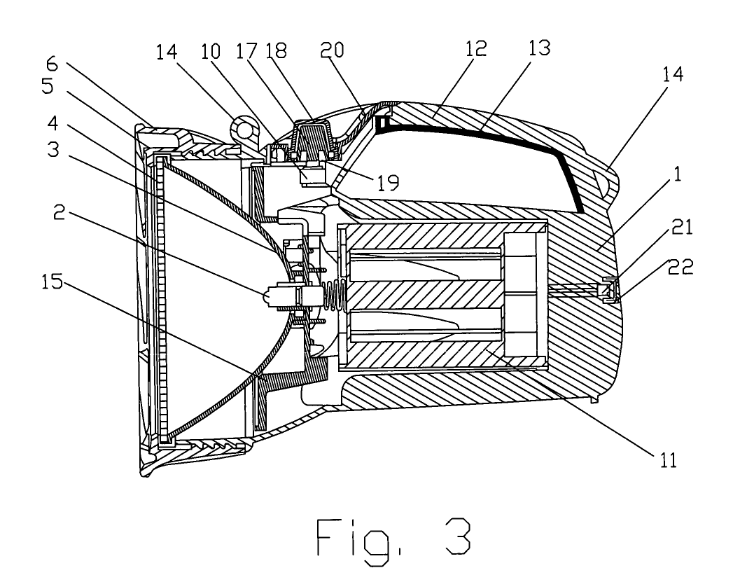

FIG. 4 is an underneath view of the present invention thereof;

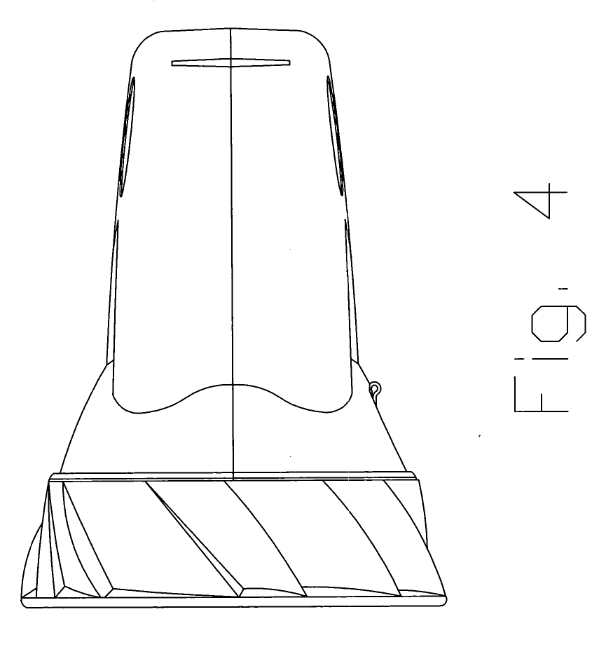

FIG. 5 is a plan view of the present invention thereof;

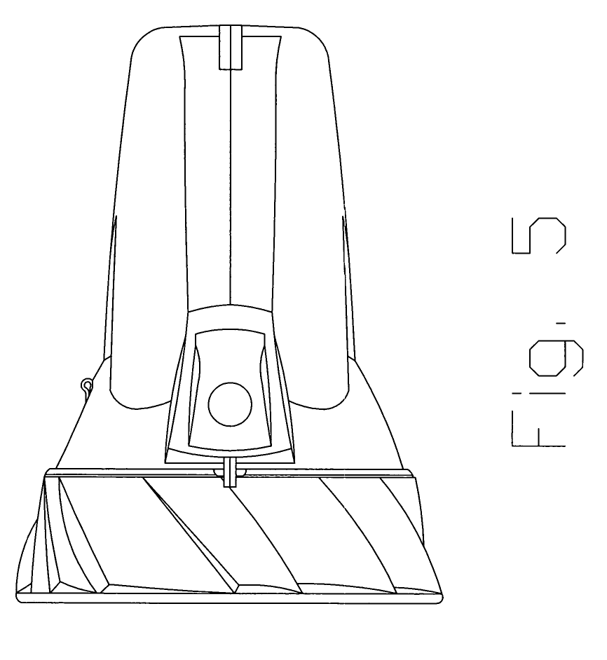

FIG. 6 is a front view of the present invention thereof;

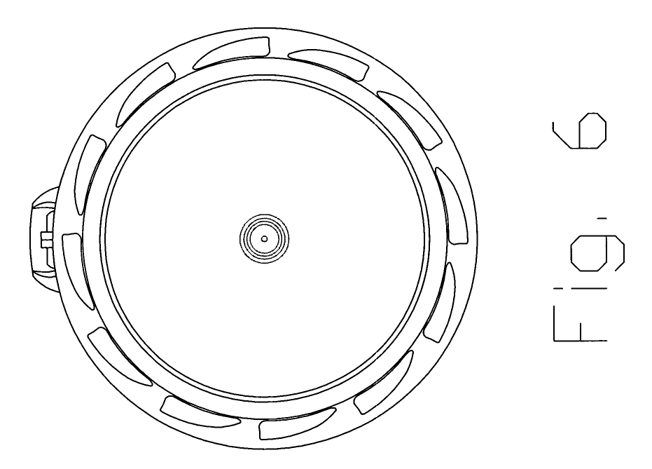

FIG. 7 is a rear view of the present invention thereof;

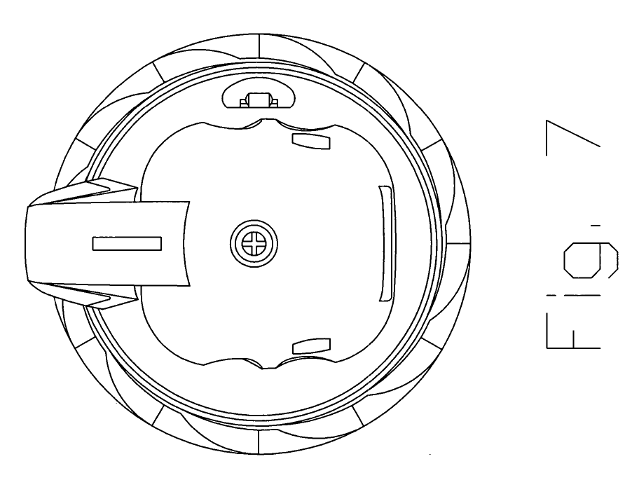

FIG. 8 is another side view of the present invention thereof;

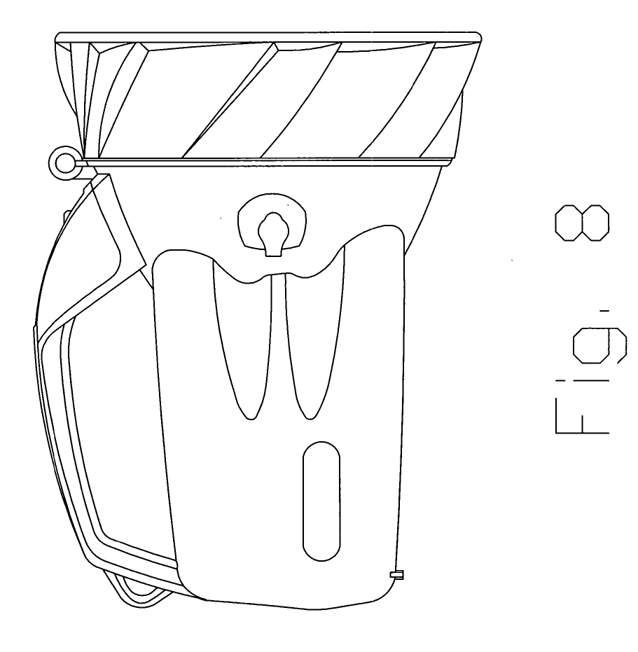

FIG. 9 is a rear isometric view of the present invention thereof;

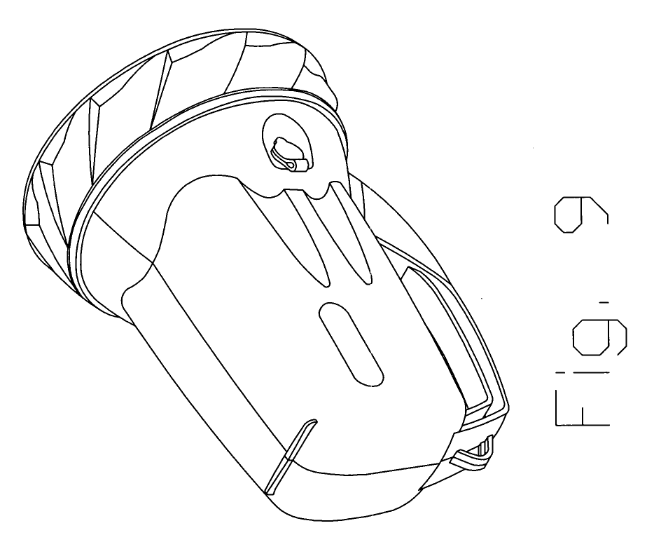

FIG. 10 is an assembly view with chargeable battery thereof;

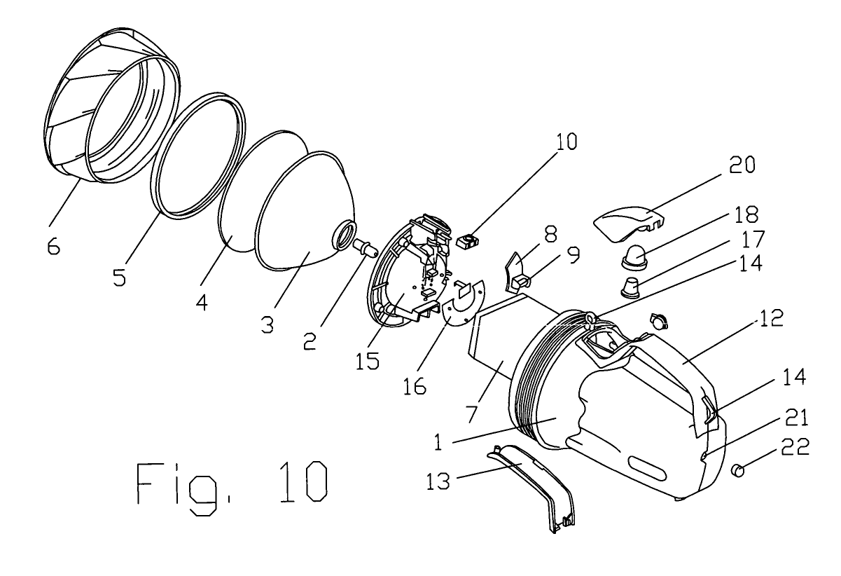

FIG. 11 is an assembly view with standard battery thereof.

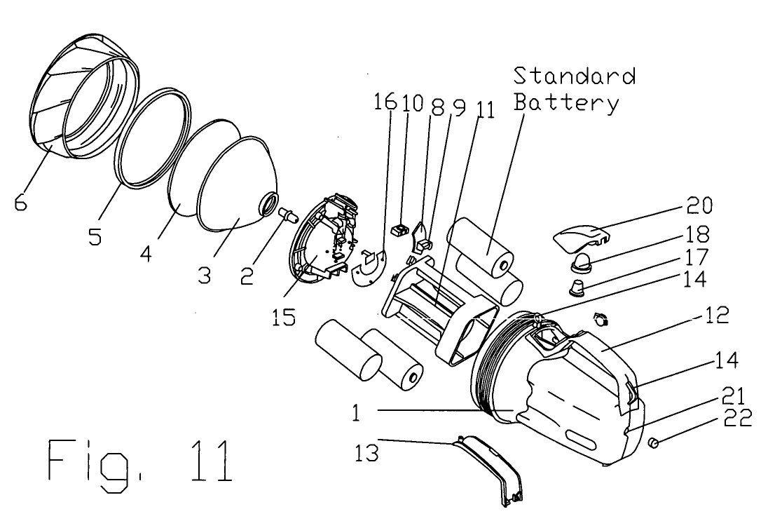

### DETAILED DESCRIPTION OF THE PREFERRED EMBODIMENT

The present invention comprises a three-dimensional-type-cylinder structure body (1), a source of lighting (2) inside said body (1), a parabola-shaped reflector (3) and a transparent front panel (4). It uses a sealing washer (5) to seal off an inner surface of said front panel (4) with said reflector's (3) surface in front of annular nut (6). Said annular nut (6) is secured in a front portion of said body (1) in a detachable manner.

As illustrated in all figures, said source of lighting (2) consists of a bulb, which is powered by a chargeable battery (7) in said body (1). A power supply is connected to an electric circuit in said body (1) via wiring. Plug receptacle (9) and switch knob (10) are connected in such a manner to control power supply from going into said electric circuit to light up and turn off said bulb. In addition, said electric circuit is having adoptability to power source generated by a battery box (11), said chargeable battery (7) and the conventional AC power supply from public utility as well as power supply generated by automobiles, boats and other means of transportation vehicles. There are also a plurality of lamp body and stand for replaceable installation of the light on the stand; Supporting means (13) are connected with said body (1). When an adjustable hinge is tightened, said supporting legs (13) are firmly fixed in one position. However, said supporting legs (13) can also provide rotating positions through a adjustable hinge to any position within 270 degrees circular arc. They provide support for said body (1) in a horizontal position to get the best lighting angle.

A handle bar (12) is connected to said body (1). Said handle bar (12) is a rectangular structure, under which there is a handle (13) made of flexible materials that provides comfortable grip for users. In both front and back portion of said handle bar (12), there are shoulder buckles (14) for convenience of carrying this spotlight by users.

Said reflector (3) inside said body (1) is connected with a frame (15), a rear surface of said frame (15), which installs contact metal plate (16) that connects to a battery power, as well as electric circuit device (8), plug receptacle (9) and switch knob (10) that connect to a bulb. It is obvious that said frame (15) is placed inside said body (1) in a moveable manner. Said contact metal plate (16) on a rear surface of said frame (15) is assembled to said battery box (11) and said chargeable battery (7) provides power alternatively.

Said switch knob (10) is secured on a top portion of said frame (15) in said body (1). There is a circular hole (19) on top portion of said switch knob (10). A circular hole (19) lies on a top portion of said body (1). Said switch knob (10) runs through said circular hole (19) in said body (1) to a pressing button (17) that is secured to an inner surface of a pressing component (18) made of flexible materials. A shield (20) is pressed and sealed onto said body (1) on top of said pressing component (18). When said button (17) is at its pressed position and connecting to said component (18), and thus said button (17) presses said switch knob (10) to connect power to lighten said bulb.

There is an exhaust pipe (21) at rear end of said body (1). An annular nut (22) made of flexible material on top of said exhaust pipe (21) is used to seal up an exit of said exhaust pipe (21) so that rain does not run through from said exit of said exhaust pipe (21) to enter into said body (1). However, should air pressure and temperature within said body (1) are higher than those outside said body (1), the air will discharge from said body (1) through said annular nut (22) made of flexible materials at said exit of said exhaust pipe (21).

From the foregoing, the present invention is easy to use in searching targets, especially useful for high-risk workers, such as navy, marine, land force, infantry, field army and air force, aerospace technicians, armed police, firefighters, riot police, special troops, public security station, disciplined force, emergency treatment, civil construction and vessels, and indispensable for amateurs of hiking, suburban expeditions, fishing and alpine skiing.

What is claimed is:

1. A stormer hi-tech super halogen spotlighting comprising:
a three-dimensional-type-cylinder structure body, wherein there is an inner chamber and a spotlight unit chamber at one end, and at least one light bulb serves as a lighting source, one arc reflective component, one switch knob and one external receptacle, and
an electric circuit device to provide power supply and adoptability to rechargeable batteries, and
a detachable power box for batteries is placed at rear end portion of said electric circuit within said body providing ability to combine batteries into a bigger power supply for extended usage, and
an arrangement for an exhaust pipe, comprises:
an annular nut made of flexible material and seals up an exit of said exhaust pipe from said top, so that rain does not run through said exit of said exhaust pipe to enter said body, wherein, should the air pressure and temperature inside the body are higher than those outside said body, the air will discharge out of said body through said annular nut at said exit of said exhaust pipe.

2. A stormer hi-tech super halogen spotlighting as recited in claim 1, wherein, said lighting consists of at least one bulb, which is powered by a chargeable battery in said body. A power supply is connected to an electric circuit in said body via wiring. Plug receptacle and switch knob are connected in such a manner to control power supply from going into said electric circuit to light up and turn off said bulb. In addition, said electric circuit is having adoptability to power source generated by a battery box and said rechargeable battery. There are also a plurality of lamp body and stand for replaceable installation of the light on the stand;

3. A stormer hi-tech super halogen spotlighting as recited in claim 1, wherein, said annular nut that is made of flexible material and seals up said exit of said exhaust pipe from the top, so that rain does not run through said exit of said exhaust pipe to enter into said body so as is the air pressure and temperature inside said body are higher than those outside of said body, the air will discharge out of said body through said annular nut at said exit of said exhaust pipe.

4. A stormer hi-tech super halogen spotlighting as recited in claim 1, wherein, said electric circuit is having a power box providing adaptability to conventional batteries in a detachable manner to form a powerful battery source, and its ability to connect to said bulb via a positive and negative electric contacts on said battery box to generate light.

5. A stormer hi-tech super halogen spotlighting as recited in claim 1, wherein, said electric circuit is having adaptability to both power source generated by a battery box (, said chargeable battery and conventional direct current power supply from wall plugs as well as power supply generated by automobiles, boats and other means of transportation vehicles.

6. A stormer hi-tech super halogen spotlighting as recited in claim 1, wherein, said supporting means are connected with said body. When an adjustable hinge is tightened, said supporting legs are firmly fixed in one position. However, said supporting means can also provide rotating positions through an adjustable hinge to any position within 270 degrees circular arc. They provide support for said body in a horizontal position to get the best lighting angle.

7. A stormer hi-tech super halogen spotlighting as recited in claim 1, wherein, wherein said stormer hi-tech super halogen spotlighting further comprises:
a handle in a rectangular shape is longitudinally attached to a rear top portion of said body. A front and rear of said handle are equipped with stripes so as to provide a mean of carrying.

8. A stormer hi-tech super halogen spotlighting as recited in claim 1, wherein, said stormer hi-tech super halogen spotlighting further comprises:
at least one light bulb,
at least one arc shaped reflector,
at least one set of main switch,
at least one power receptacle for external electricity,
at least one transformer, and
at least one set of circuitry and power supply.

9. A stormer hi-tech super halogen spotlighting as recited in claim 1, wherein said supporting means can provide an adjustable mean with a tight or loose positions so as to controlling such supporting means in a locked position or in a rotating position to reach the best lighting range and lighting angles through said attached hinge to any position within 270 degrees circular ark. Said legs provide supports for said housing.

10. A supporting means as recited in claim 6, wherein said supporting means can provide an adjustable mean with a tight or loose positions so as to controlling such supporting legs in a locked position or in a rotating position to reach the best lighting range and lighting angles through said attached hinge to any position within 270 degrees circular ark. Said legs provide supports for said housing.

11. A stormer hi-tech super halogen spotlighting as recited in claim 1, wherein said stormer hi-tech super halogen spotlighting can draw electricity either from AC power outlet provided from public utility or from the chargeable battery directly.
